(19) United States
(12) Patent Application Publication
(10) Pub. No.: US 2017/0249512 A1
(43) Pub. Date: Aug. 31, 2017

(54) REMOTE DETECTION OF INSECT INFESTATION

(71) Applicant: Tolo, Inc., Los Altos, CA (US)

(72) Inventors: Iain Richard Tyrone MCCLATCHIE, Los Altos, CA (US); David Levy KANTER, San Francisco, CA (US)

(21) Appl. No.: 15/518,226

(22) PCT Filed: Oct. 21, 2015
(86) PCT No.: PCT/US15/56762

§ 371 Date: Apr. 10, 2017

Related U.S. Application Data
(60) Provisional application No. 62/066,876, filed on Oct. 21, 2014.

(51) Int. Cl. G06K 9/00; A01G 23/00; G06Q 50/02; A01M 1/02

(52) U.S. Cl. CPC G06K 9/00657; A01M 1/026; A01G 23/00; G06Q 50/02; G06K 2209/19

(57) ABSTRACT

Techniques for remote detection of insect infestation are described. In a first aspect, an aerial platform operates above trees and captures imagery of the trees suitable for detecting indicators of insect infestation. In a second aspect, imagery of trees captured by an aerial platform operated above the trees is analyzed to detect indicators of insect infestation. In a third aspect, the capturing of imagery of the trees is performed by a camera that dynamically adjusts the point of focus relative to the ground and/or top of the trees. In particular embodiments, the imagery is oblique imagery. In selected embodiments, the capturing of imagery comprises down-sampling or discarding portions of the imagery. In portions of some embodiments, the detection employs machine-learning techniques, such as convolved neural nets.

### CROSS REFERENCE TO RELATED APPLICATIONS

Related techniques are described in the following, which this application incorporates by reference for all purposes to the extent permitted:
U.S. Provisional Application (Docket No. TL-14-02B and Ser. No. 62/066,876), filed 21 Oct. 2014, first named inventor kin Richard Tyrone McClatchie, and entitled REMOTE DETECTION OF INSECT INFESTATION;
U.S. Non-Provisional application (Docket No. TL-13-03NP and Ser. No. 14/159,360, now published as US 2015-0264262 A1), filed 20 Jan. 2014, first named inventor kin Richard Tyrone McClatchie, and entitled HYBRID STABILIZER WITH OPTIMIZED RESONANT AND CONTROL LOOP FREQUENCIES;
PCT Application (Docket No. TL-12-01PCTA and Serial No. PCT/US2014/030068, now published as WO 2014/145328), filed 15 Mar. 2014, first named inventor kin Richard Tyrone McClatchie, and entitled DIAGONAL COLLECTION OF OBLIQUE IMAGERY; and
PCT Application (Docket No. TL-12-01PCTB and Serial No. PCT/US2014/030058, now published as WO 2014/145319), filed 15 Mar. 2014, first named inventor kin Richard Tyrone McClatchie, and entitled DISTORTION CORRECTING SENSORS FOR DIAGONAL COLLECTION OF OBLIQUE IMAGERY.
   Unless expressly identified as being publicly or well known, mention above or elsewhere herein of techniques and concepts, including for context, definitions, or comparison purposes, should not be construed as an admission that such techniques and concepts are previously publicly known or otherwise part of the prior art.

### BACKGROUND

### Field

Advancements in insect detection are needed to provide improvements in performance, efficiency, and utility of use.

### SYNOPSIS

The invention may be implemented in numerous ways, including as a process, an article of manufacture, an apparatus, a system, a composition of matter, and a computer readable medium such as a computer readable storage medium (e.g. media in an optical and/or magnetic mass storage device such as a disk, or an integrated circuit having non-volatile storage such as flash storage) or a computer network wherein program instructions are sent over optical or electronic communication links. In this specification, these implementations, or any other form that the invention may take, may be referred to as techniques. The Detailed Description provides an exposition of one or more embodiments of the invention that enable improvements in performance, efficiency, and utility of use in the field identified above. The Detailed Description includes an Introduction to facilitate the more rapid understanding of the remainder of the Detailed Description. The Introduction includes Example Embodiments of one or more of systems, methods, articles of manufacture, and computer readable media in accordance with the concepts described herein. As is discussed in more detail in the Conclusions, the invention encompasses all possible modifications and variations within the scope of the issued claims.

### BRIEF DESCRIPTION OF DRAWINGS

FIG. 1 conceptually illustrates selected details of a side view of an airplane carrying cameras and capturing oblique imagery of trees to detect the presence of pitch tubes on the trees.

FIG. 2 conceptually illustrates selected details of an example flight plan for an embodiment of capturing oblique imagery of a forest.

FIG. 3A conceptually illustrates selected details of analyzing oblique imagery to detect bark beetles in a tree.

FIG. 3B conceptually illustrates selected details of improving bark beetle detector accuracy and/or performance.

FIG. 4 illustrates a flow diagram of selected details of detecting bark beetles.

FIG. 5 illustrates selected details of embodiments of techniques for remote detection of insect infestation.

### DETAILED DESCRIPTION

A detailed description of one or more embodiments of the invention is provided below along with accompanying figures illustrating selected details of the invention. The invention is described in connection with the embodiments. The embodiments herein are understood to be merely exemplary, the invention is expressly not limited to or by any or all of the embodiments herein, and the invention encompasses numerous alternatives, modifications, and equivalents. To avoid monotony in the exposition, a variety of word labels (including but not limited to: first, last, certain, various, further, other, particular, select, some, and notable) may be applied to separate sets of embodiments; as used herein such labels are expressly not meant to convey quality, or any form of preference or prejudice, but merely to conveniently distinguish among the separate sets. The order of some operations of disclosed processes is alterable within the scope of the invention. Wherever multiple embodiments serve to describe variations in process, method, and/or program instruction features, other embodiments are contemplated that in accordance with a predetermined or a dynamically determined criterion perform static and/or dynamic selection of one of a plurality of modes of operation corresponding respectively to a plurality of the multiple embodiments. Numerous specific details are set forth in the following description to provide a thorough understanding of the invention. The details are provided for the purpose of example and the invention may be practiced according to the claims without some or all of the details. For the purpose of clarity, technical material that is known in the technical fields related to the invention has not been described in detail so that the invention is not unnecessarily obscured.

### Introduction

This introduction is included only to facilitate the more rapid understanding of the Detailed Description; the invention is not limited to the concepts presented in the introduction (including explicit examples, if any), as the paragraphs of any introduction are necessarily an abridged view of the entire subject and are not meant to be an exhaustive or restrictive description. For example, the introduction that follows provides overview information limited by space and organization to only certain embodiments. There are many other embodiments, including those to which claims will ultimately be drawn, discussed throughout the balance of the specification.

### System and Operation

An example of a bark beetle is a beetle that reproduces in the inner bark (phloem tissues) of trees. An example species of bark beetle is the Mountain Pine Beetle of North America, which attacks and kills Ponderosa, Lodgepole, and in some cases Jack pine trees.

In some scenarios, adult bark beetles emerge from trees in July through September, and fly to attack fresh new trees. In some circumstances, bark beetles can fly over 100 kilometers to attack new trees, bypassing natural barriers such as mountains and lakes. The bark beetles bore through the bark and inoculate the tree with a fungus that reduces the tree's defensive response. In some scenarios, the fungus stains the phloem and sapwood of the tree (e.g., blue or grey). To combat the beetle, an attacked tree produces a fluid in the bores that is variously called resin, latex, or pitch. Pitch may immobilize and suffocate the insects and contains chemicals to kill the beetle and the fungus it carries. The beetles use pheromones to coordinate an attack, in some scenarios individual trees are attacked by hundreds of beetles simultaneously, so as to overwhelm the tree's defenses. In some scenarios, weakened trees (e.g., due to previous attacks or drought) may not produce sufficient pitch to repel the beetles. In some scenarios, a tree exhibits characteristic symptoms within a week of being attacked by bark beetles. In some scenarios, bark beetles prefer to attack the north side of a tree and typically concentrate in the lower third of the trunk of the tree.

Frass is an example of a characteristic symptom of a bark beetle attack. Frass comprises partially digested wood fibers cut from the bark as the bark beetles bore through the bark. In some scenarios, the frass falls to the ground around the base of the attacked tree.

Pitch tubes are an example of a characteristic symptom of a bark beetle attack. Pitch tubes comprise frass mixed with the pitch exuded by the tree once the insect cuts into the phloem layer. In some scenarios, the pitch tubes harden in contact with the air and form visible blobs on the trunk of the tree. The mixture of frass and hardened pitch is often a different color, e.g., yellow or orange, compared to the bark of the tree. In various scenarios, the number of pitch tubes on a tree corresponds to the intensity of the attack and the likelihood of the tree dying.

An example of a green attack tree is a tree where adult beetles have bored into the phloem of the attacked tree and in some scenarios, have also laid eggs. Most of the tree's capacity for moving nutrients and water vertically is intact and the foliage remains green, however, the tree will likely die as the attack progresses. Once the eggs hatch the pupae develop through several molts into adults. In the process, the bark beetles eat through the phloem around the circumference of the tree, thereby eliminating the tree's ability to transport water and nutrients vertically.

An example of a red attack tree is a tree that has been attacked by bark beetles where the needles of the attacked tree have lost their chlorophyll and turned red. The bark beetles damage the phloem of the tree, which prevents transportation of water and nutrients vertically and as a result, the chlorophyll in the needles breaks down, turning the needles red. In some scenarios, a green attack tree becomes a red attack tree after approximately one year.

In some scenarios, once the bark beetles have matured into adults inside an attacked tree, the bark beetles bore out of the tree and repeat the cycle again, flying to a new tree in July through August (e.g. summer in the northern hemisphere). In some cases, pitch tubes are not formed as a result of exit bores, because the tree no longer produces pitch.

In some embodiments, detecting a green attack tree is highly beneficial, since the tree can be cut down for lumber and sanitized to kill the bark beetles and prevent the bark beetles from flying to a new tree. In some scenarios, the bark beetles can be killed before the fungus has stained the phloem and sapwood of the tree, which increases the value of the lumber from the tree. In some other scenarios, trees that cannot be harvested for lumber are burned to prevent the spread of the bark beetle.

In some embodiments, remote detection of insect infestation (e.g., remotely detecting green attack trees via aerial image capture and analysis) is less expensive, more scalable, and more flexible than visual inspection. For example, an inspector is restricted to examining sites that are safely accessible to humans (e.g., in close proximity to roads), whereas an aerial platform can visit sites that are difficult or impossible for humans to safely visit. As another example, an aerial platform can detect green attack trees across hundreds or thousands of square kilometers every day, whereas a human inspector is limited to a much smaller area.

An example of a canopy is the combined foliage (e.g., leaves, needles) of many trees within a forest. For example, Lodgepole and Ponderosa pines are characterized by a strong, straight, central trunk and conically tapering foliage on much shorter branches from this trunk. E.g., in a Lodgepole or Ponderosa pine forest, the foliage is concentrated near the upper third of the tree trunk's height. In dense forest the canopy intercepts the majority of the sunlight, and also occludes much of the tree trunks from direct view.

An example of a nadir (or orthographic) perspective is a camera perspective looking straight down. In some embodiments and/or scenarios, this is also the perspective of the captured images (e.g. nadir imagery captured by a nadir camera). An example of an emerging optical axis of a camera is the path along which light travels from the ground at the center of the lens field of view to arrive at the entrance to the camera. An example of an oblique perspective is a camera perspective looking down at an angle below the horizon but not straight down. An example of a down angle of a camera is the angle of the emerging optical axis of the camera above or below the horizon; down angles for nadir perspectives are thus 90 degrees; example down angles for oblique perspectives are from 20 to 70 degrees. In some embodiments and/or scenarios, the camera used to capture an oblique perspective is referred to as an oblique camera and the resulting images are referred to as oblique imagery. In some scenarios, oblique imagery, compared to nadir imagery, provides relatively more information about relative heights of objects and/or relatively more information about some surfaces (e.g. vertical faces of trees).

Elsewhere herein, various embodiments relating to bark beetle infestation of trees are described. Other embodiments use similar concepts to detect other types of economic hazards (e.g. beetles other than bark beetles, insects of any kind, nutrition and/or water deficiencies, fungi, disease, or other problems) relating to crops (e.g. any cultivated plant, fungus, or alga that is harvestable for food, clothing, livestock fodder, biofuel, medicine, or other uses).

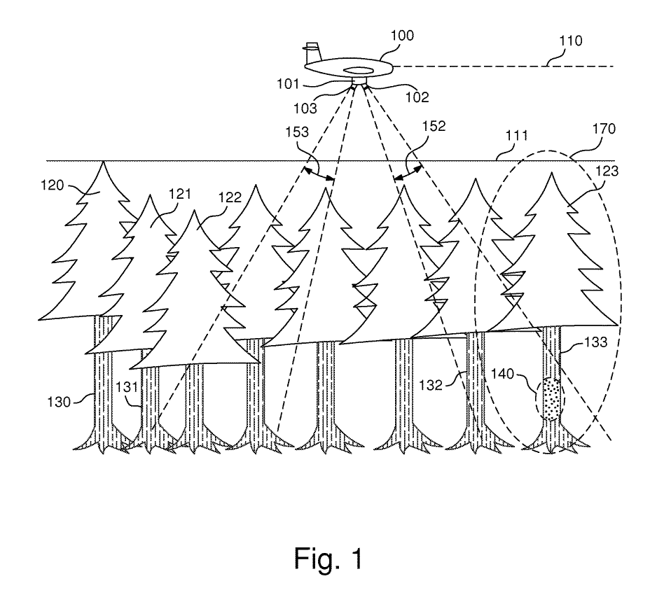

FIG. 1 conceptually illustrates selected details of a side view of an airplane carrying cameras and capturing oblique imagery of trees to detect the presence of pitch tubes on the trees. Airplane 100 flies along Path 110 that is above Canopy Local Maximum Altitude 111. The canopy comprises Foliage 120, 121, 122, and 123 of the trees in the forest. Airplane carries Payload 101, in some embodiments the Payload comprises Cameras 102 and 103. In various embodiments, the Cameras are enabled to capture oblique imagery via one or more electronic image sensors (e.g., CMOS or CCD image sensors, and/or an array of CMOS or CCD image sensors). In various embodiments, the Cameras are enabled to capture infrared radiation, e.g. long wave infrared such as useful for measuring ground temperature, medium wave infrared such as useful for measuring equipment, vehicle, and people temperatures, and near infrared such as useful for determining chlorophyll levels. Cameras have respective Fields of View 152 and 153. In some scenarios, the Cameras capture oblique images of portions of Tree Trunks 130, 132 and 133 and other portions of the Tree Trunks are obscured by Foliage. In some scenarios, a tree trunk that is obscured by foliage is subsequently visible. For example, Tree Trunk 131 is not captured by the Cameras in the position shown, but may be captured when the Airplane moves to a different point along the Path. In some embodiments, the Cameras capture nadir imagery. In various embodiments, the Cameras are configured with diagonal plan angles (e.g., 45 degree, 135 degree, 225 degree, and 315 degree plan angles relative to the nominal heading of the Airplane).

Tree Trunk 133 is of a green attack tree (e.g., it has been attacked by bark beetles) and information regarding Pitch Tubes 140 is captured by Camera 102. In some scenarios, the Pitch Tubes are 1.5-2.5 centimeters wide. In various embodiments, it is beneficial for the Cameras to resolve pixels that are approximately 4 millimeters wide on a side when projected to the ground (e.g., the ground sample distance or GSD) to enable capturing the Pitch Tubes across a sufficient number of pixels. Effective exposure time of the Camera is sufficiently long so that the signal-to-noise ratio (SNR) of the imagery is high enough to enable distinguishing the Pitch Tubes from the bark of the Tree Trunk. In some embodiments, an SNR of at least 5:1 is obtained, and a greater SNR is better and eases subsequent analysis. In various embodiments, an effective exposure time of 5 milliseconds, with an F/4 lens, and ISO 400 sensitivity achieves a SNR of 5:1 under some operating conditions (e.g., nominal weather, lighting, etc.). In some embodiments, multiple exposures are combined to achieve a sufficiently long effective exposure time; in various embodiments time delay integration is used to improve effective exposure time. In various embodiments, the Cameras use an optical filter that restricts the wavelengths received to wavelengths with the greatest contrast between pitch tubes and bark to increase the SNR.

For imaging a fixed size object (e.g., Pitch Tubes 140) under varying conditions, a relevant metric for blur is blur at the object. In contrast, for some photography blur is measured at the image. In various embodiments, cameras with a small GSD have a limited focus range. For example, a camera that captures imagery with 4 millimeter GSD has less than one pixel of blur within +/−29 meters of the focus plane. As a result, the Camera is enabled to focus on only a portion of a tree (e.g., Tree 170). In some scenarios, it is possible that the limited focus of the Camera results in oblique imagery where pitch tubes are not in focus (e.g., if the Pitch Tubes are at approximately ground level and the focus point is 45 meters in altitude with a focus range of +/−29 meters). In various embodiments, focus point of the Camera is dynamically maintained relative to either the ground or the canopy, to improve the likelihood that the Pitch Tubes are captured in focus. In various embodiments, the elevation of the ground and/or canopy are determined by one or more of: LiDAR, RADAR, an existing ground elevation map, and measuring parallax between subsequent images.

In various embodiments, the focus point of the Camera is dynamically maintained at an expected, predicted, and/or predetermined elevation corresponding to any portion of Pitch Tubes 140, such the bottom, center, or top of the Pitch Tubes, improving, in some usage scenarios, the likelihood that the Pitch Tubes are captured in focus. In various embodiments, the focus point of the Camera is dynamically maintained at an expected, predicted, and/or predetermined elevation corresponding to where infestations could occur on a tree trunk and/or where infestations would be visible on a tree trunk, improving, in some usage scenarios, the likelihood that the Pitch Tubes are captured in focus.

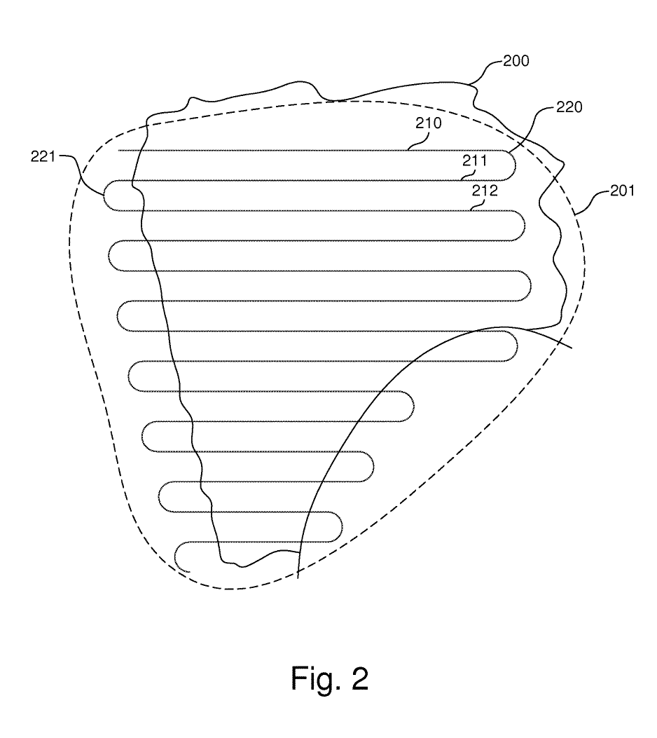

FIG. 2 conceptually illustrates selected details of an example flight plan for an embodiment of capturing oblique imagery of a forest. Region 200 comprises a forest of trees that are potentially infested with bark beetles. Flight Plan 201 comprises flight lines (e.g., 210, 211, and 212) separated by turns (e.g., 220, 221). An aerial platform (e.g., Plane 100) flies along flight lines at a selected altitude and captures imagery (e.g., oblique and/or nadir) of the forest using one or more cameras with electronic image sensors (e.g., Cameras 102, 103). In some embodiments, the Flight Plan is selected such that multiple oblique images of the entire forest is captured (e.g., each point in the forest is captured in 10 different oblique images, taken from the plane while in 10 different positions using one or more of the Cameras) to maximize the likelihood that the oblique images capture the trunks of the trees in the forest. In various embodiments, the selected altitude is selected to achieve a desired resolution (e.g., 4 millimeter GSD). In some scenarios, the forest is on terrain of varying elevation (e.g. mountains and/or valleys), and the selected altitude is maintained while the focus points of the Cameras are dynamically maintained relative to the ground or canopy.

In various embodiments, the oblique imagery is obtained by one or more “flights” by one or more aerial platforms and/or machines, such as, one or more planes, helicopters, drones, balloons, and/or blimps. In various embodiments, the oblique imagery is obtained by one or more flights by one or more imagery platforms and/or machines (such as rail-based and “flown wire” cable-suspended cameras) attached to, mechanically coupled to, suspended from, and/or otherwise associated with static and/or moving infrastructure, such as, infrastructure of greenhouses, habitats, warehouses, moving irrigation machines, and/or structures taller than crops the oblique imagery is being obtained for. In various embodiments, imagery platforms communicate imagery data via networking, such as via wired and/or wireless networking.

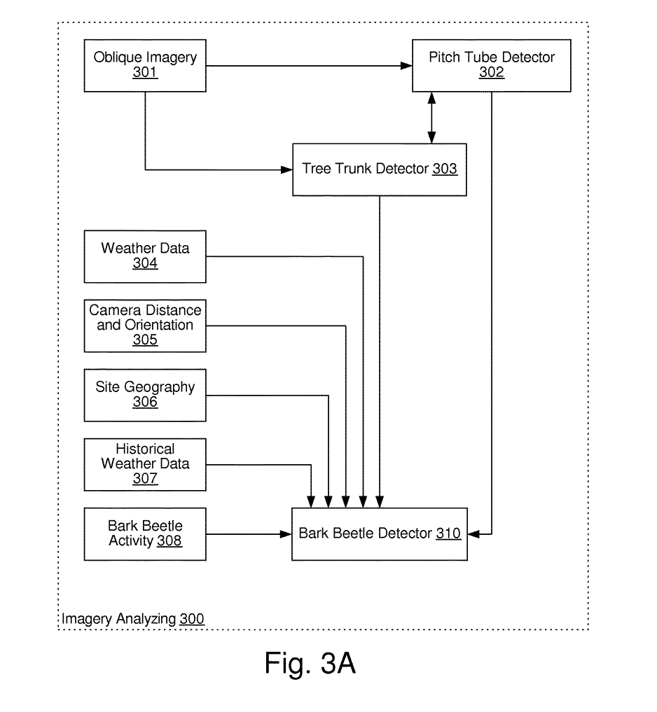

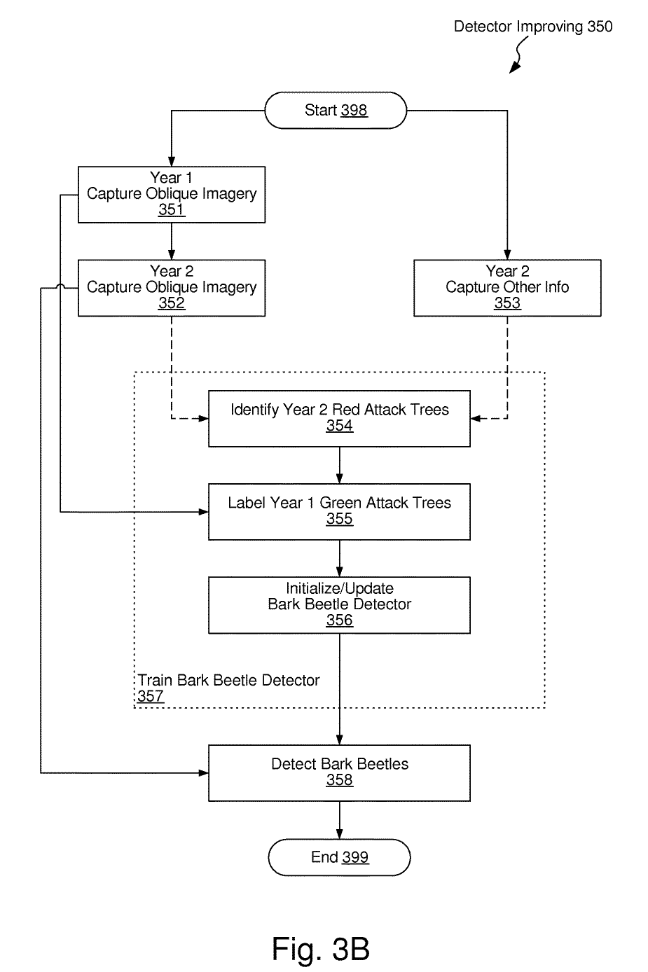

FIG. 3A conceptually illustrates selected details of analyzing oblique imagery to detect bark beetles in a tree, as Imagery Analyzing 300. Oblique Imagery 301 comprises oblique imagery (e.g., captured by Cameras 102 and 103) of the tree, e.g., foliage of the tree, the trunk of the tree, foliage of other trees that occludes the tree. Oblique imagery is analyzed by Pitch Tube Detector 302, which analyzes the imagery to detect likely locations of pitch tubes, e.g., using a machine-learning algorithm. The Pitch Tube Detector outputs likely pitch tube locations in the Oblique Imagery to Bark Beetle Detector 310 (conceptually corresponding to a green attack tree predictor). Oblique imagery is analyzed by Tree Trunk Detector 303, which analyzes the imagery to detect likely locations of tree trunks, e.g., using a machine-learning algorithm. The Tree Trunk Detector outputs likely tree trunks in the Oblique Imagery to Bark Beetle Detector 310. In some embodiments, the Tree Trunk Detector also estimates and outputs the species of the tree to determine whether the tree is vulnerable to bark beetles (e.g., Red Fir trees are immune to Mountain Pine Beetle, therefore are ignored when detecting Mountain Pine Beetle). In various embodiments, the Tree Trunk Detector and the Pitch Tube Detector receive and transmit input from one another.

Weather Data 304 comprises information about the weather when the Oblique Imagery was captured (e.g., rain, cloudy, angle of the sun, etc.). Camera Distance and Orientation 305 comprises the estimated or measured distance of the Camera from the captured imagery, and the orientation of the Camera (e.g., down angle from the horizon and plan angle from North). Site Geography 306 comprises information such as the altitude, slope of the ground, direction of the slope, latitude, longitude, distance from nearest water, and topography of the area around the object (e.g., the area around Tree 170). Historical Weather Data 307 comprises past weather information, e.g., rainfall, snowpack, and/or degree-days of heat in previous months or years. Bark Beetle Activity 308 comprises data about bark beetle activity, e.g., location and intensity of nearby infestations.

Bark Beetle Detector 310 receives input from the Pitch Tube Detector, the Tree Trunk Detector, the Weather Data, the Camera Distance and Orientation, the Site Geography, the Historical Weather Data, and the Bark Beetle Activity and estimates the likelihood that a tree (e.g., Tree 170) has bark beetles (e.g., is a green-attack tree). In some embodiments, the Bark Beetle Detector uses a classifier or other machine-learning algorithm. In some embodiments, one or more of the Pitch Tube Detector and the Tree Trunk Detector receive input from one or more of the Weather Data, the Camera Distance and Orientation, the Site Geography, the Historical Weather Data, and the Bark Beetle Activity. In various embodiments, the Bark Beetle Detector receives input from the Oblique Imagery.

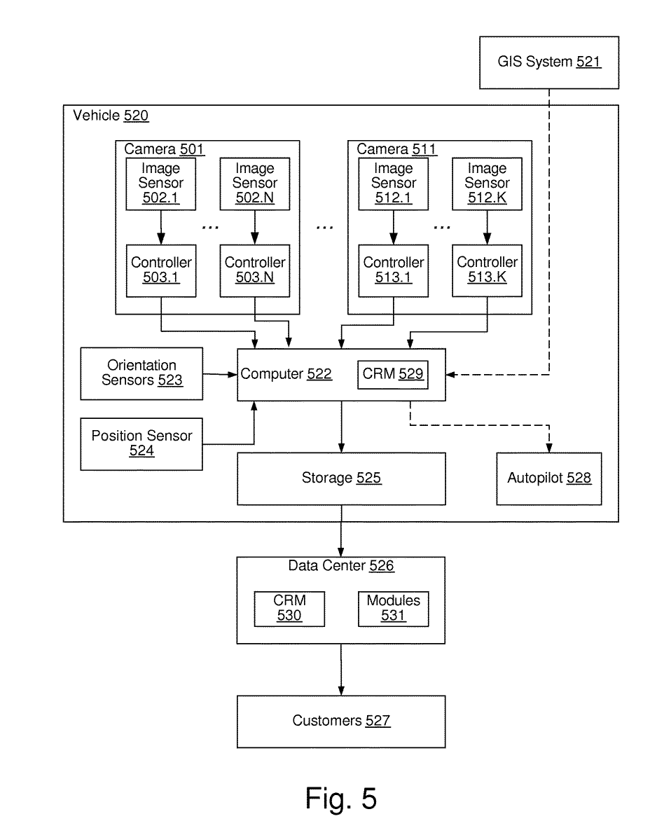

In various embodiments, any one or more of the elements of FIG. 3A (e.g. any combination of Pitch Tube Detector 302, Tree Trunk Detector 303, and/or Bark Beetle Detector 310) are implemented wholly or partially via one or more machine-learning techniques, such as via one or more classification and/or segmentation engines. In various embodiments, any one or more of the classification and/or segmentation engines are included in various software and/or hardware modules (such as Modules 531 of FIG. 5, described elsewhere herein). In various embodiments, any one or more of the classification engines are implemented via one or more neural nets (e.g. convolved neural nets), such as implemented by Modules 531.

As a specific example, Pitch Tube Detector 302 and/or 303 are implemented at least in part via respective classification engines enabled to receive various image data portions selected in size to include one or more trees, such as including one or more trunks of trees. An exemplary classification engine used for Pitch Tube Detector 302 classifies each respective image data portion as to whether the respective image data portion includes one or more pitch tubes. Another exemplary classification engine used for Pitch Tube Detector 302 classifies each respective image data portion as to whether the respective image data portion is determined to correspond to pitch tubes and/or other indicia predictive of pitch tubes. An exemplary classification engine used for Tree Trunk Detector 303 classifies each respective image data portion as to whether the respective image data portion includes one or more tree trunks and/or portions thereof.

In various embodiments, any one or more of the elements of FIG. 3A (e.g. any combination of Pitch Tube Detector 302 and/or Tree Trunk Detector 303) are implemented wholly or partially via one or more recognizers specific to, e.g., pitch tube and/or tree trunk image characteristics.

In various embodiments, processing performed by Pitch Tube Detector 302 and/or Tree Trunk Detector 303 is subsumed by processing performed by Bark Beetle Detector 310. In various embodiments, a single machine-learning agent (e.g., implemented by one or more convolved neural nets) performs processing in accordance with Pitch Tube Detector 302, Tree Trunk Detector 303, and/or Bark Beetle Detector 310.

In various embodiments, any one or more of the Bark Beetle Detector, the Pitch Tube Detector, and the Tree Trunk Detector are trained using previously captured data. In year 1, any one or more of the Oblique Imagery, the Pitch Tube Detector predictions, the Tree Trunk Detector predictions, the Weather Data, the Camera Distance and Orientation, the Site Geography, the Historical Weather Data, and the Bark Beetle Activity are captured (e.g., for all trees in Region 200). In some scenarios, after a year has elapsed (e.g., year 2), some trees that have been previously attacked by bark beetles have become red attack trees (e.g., the trees have been killed by the bark beetles). In some scenarios, red attack trees are identifiable using various image capturing techniques, e.g., high-resolution satellite imagery and/or aerial imagery. In some embodiments, red attack trees are identified using the Oblique Imagery captured in year 2. The red attack trees are labeled as green attack trees in the Oblique Imagery from year 1 and used to train any one or more of the Bark Beetle Detector, the Pitch Tube Detector, and the Tree Trunk Detector to better detect bark beetles, pitch tubes, and tree trunks, respectively. In various embodiments, all or any portions of previously captured data is used to train any one or more of the Bark Beetle Detector, the Pitch Tube Detector, and the Tree Trunk Detector (e.g., previously captured data from years 1 through N is used to train estimates for year N+1). In some embodiments, previously captured data in one region (e.g., British Columbia) is used to train estimates for another region (e.g., Alberta).

Regarding the foregoing, FIG. 3B conceptually illustrates selected details of improving bark beetle detector accuracy and/or performance in an example usage context, as Detector Improving 350. The Detector Improving begins with Start 398. In year 1, information is captured (e.g. via storing and/or retaining all or any portions of results of any one or more of Oblique Imagery 301, Pitch Tube Detector 302 predictions, Tree Trunk Detector 303 predictions, Weather Data 304, Camera Distance and Orientation 305, Site Geography 306, Historical Weather Data 307, and Bark Beetle Activity 308; all of FIG. 3A), for various trees in Region 200 of FIG. 2. The year 1 information capture is illustrated conceptually as Year 1 Capture Oblique Imagery 351.

In year 2, all or any portions of the information capture of year 1 is repeated, as illustrated conceptually as Year 2 Capture Oblique Imagery 352. In year 2, other information is captured (e.g. via storing and/or retaining nadir imagery, imagery of a lower resolution than Oblique Imagery 301, imagery obtained via focusing on the canopy or ground of Region 200, and/or imagery obtained without focusing specifically on tree trunks), as illustrated in Year 2 Capture Other Info 353. In year 2, red attack trees are identified using all or any portions of results of Year 2 Capture Other Info 353, as illustrated by Identify Year 2 Red Attack Trees 354. The red attack trees are labeled as green attack trees in the Oblique Imagery from year 1, illustrated conceptually as Label Year 1 Green Attack Trees 355.

Using all or any portions of results of Label Year 1 Green Attack Trees 355, accuracy and/or performance any one or more of Bark Beetle Detector 310, Pitch Tube Detector 302, and Tree Trunk Detector 303 are improved to better detect bark beetles, pitch tubes, and tree trunks, respectively, as illustrated conceptually by Initialize/Update Bark Beetle Detector 356. Bark beetles are then detected using all or any portions of results of Year 2 Capture Oblique Imagery 352 and improvements as made via Initialize/Update Bark Beetle Detector 356 (e.g. to Bark Beetle Detector 310), as illustrated conceptually by Detect Bark Beetles 358 (conceptually corresponding to predict green attack trees). In various embodiments, one or more of a database, table, log, diary, listing, inventory, and/or accounting related to Year 2 Capture Oblique Imagery 352 is updated to indicate which particular trees and/or locations thereof have been detected as having bark beetles, and/or updated to indicate which of a plurality of states trees are in, e.g., healthy, green attack, red attack, and/or dead, based on results of Detect Bark Beetles 358. The Detector Improving is then complete (End 399).

In various embodiments, all or any portions of Train Bark Beetle Detector 357 are implemented at least in part by one or more convolved neural nets, such as by updating one or more weights of the convolved neural nets. In various embodiments, all or any portions of Train Bark Beetle Detector 357 are implemented at least in part by machine-learning techniques, such as via one or more classification and/or segmentation engines. In various embodiments, any one or more of the classification and/or segmentation engines are included in various software and/or hardware modules (such as Modules 531 of FIG. 5, described elsewhere herein). In various embodiments, any one or more of the classification engines are implemented via one or more convolved neural nets, such as implemented by Modules 531.

An example embodiment of a neural net (e.g. a convolved neural net) implementation of bark beetle detecting (e.g. to implement all or any portions of Detect Bark Beetles 358) includes inputs corresponding to 4000 by 4000 pixels of image data (e.g. representing 16 meters by 16 meters of image data). The neural net simultaneously considers multiple images taken of roughly a same central 8-meter diameter volume at roughly a same time (e.g. within one minute). Optionally, multiple oblique perspectives are used to enable increased robustness of detecting, such as two or three oblique perspectives with separations of ten degrees, corresponding conceptually to stereo imagery, and the multiple oblique perspectives enable “seeing through” foliage.

A first layer of the neural net includes filters of 15×15 pixels, with 50 filter channels (e.g. 11,250 total parameters). A second layer of the neural net includes pooling of 4×4 on each of the 50 filter channels. Third and fourth layers included in the neural net are convolutional and then pooling. Fifth and sixth layers included in the neural net are convolutional and then pooling. The fifth and sixth layers combine images by convolving each pixel of a particular image with pixels of another particular image that the particular image might be stereographically matched to. The pooling is synchronized across the filter channels. Additional layers are optionally included in the neural net following the fifth and sixth layers. The additional layers are relatively more fully connected. The top one or more layers are optionally fully connected.

In various embodiments, the image data is available in three “stereo” images of each location (e.g. corresponding to a spot on the ground), and different color filters are used for each of the three stereo images. In some usage scenarios, using the color filters enables picking out particular bands of light that provide more distinction between bark and pitch tubes. E.g., three relatively small bands of light centering around 1080 nm, 1130 nm, and 1250 nm are useful, in some usage scenarios, for distinguishing bark from pitch tubes. In some embodiments, a particularly doped CMOS or CCD sensor enables imaging of the three relatively small bands of light, e.g. 950 nm to 1250 nm.

In various embodiments, “year 1” and “year 2” as described with respect to FIG. 3B are representative of any two consecutive years, such as year 2 and year 3, year 3 and year 4, or more generally as year N and year N+1. In some embodiments, first and second years of operation according to Detector Improving 350 result in initialization of a detector, such as Bark Beetle Detector 310. Subsequent years of operation according to Detector Improving 350 result in one or more modifications to the detector, e.g., via updates to one or more weights of one or more convolved neural nets implementing all or any portions of the detector.

In various embodiments, all or any portions of results from Year 2 Capture Other Info 353 are used without any results of Year 2 Capture Oblique Imagery 352 to perform Identify Year 2 Red Attack Trees 354. In various embodiments, all or any portions of results from Year 2 Capture Oblique Imagery 352 are used without any results of Year 2 Capture Other Info 353 to perform Identify Year 2 Red Attack Trees 354. In various embodiments, all or any portions of results from Year 2 Capture Oblique Imagery 352 as well as all or any portions of results from Year 2 Capture Other Info 353 are used to perform Identify Year 2 Red Attack Trees 354.

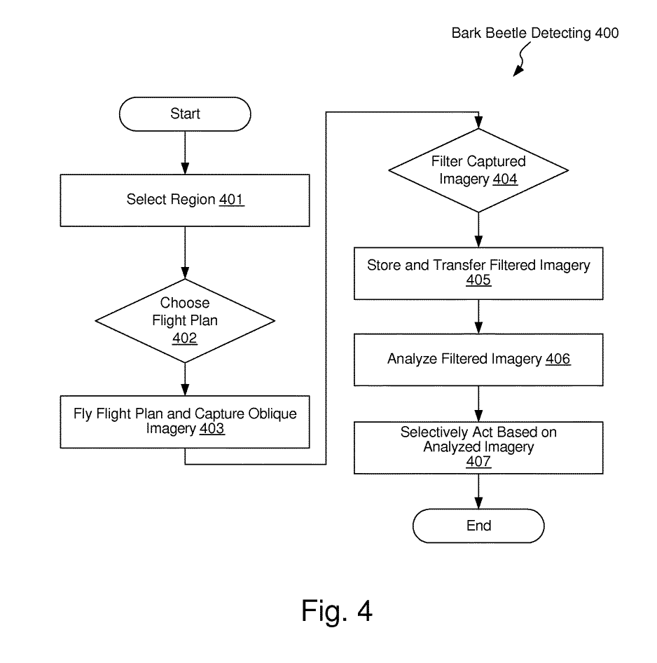

FIG. 4 illustrates a flow diagram of selected details of detecting bark beetles, as Bark Beetle Detecting 400. In action 401, a region is selected for inspection (e.g., Region 200). In action 402, a flight plan is generated for the selected region (e.g., Flight Plan 201). Action 401 and 402 are completed before Action 403 begins, in some embodiments.

In action 403, an aerial platform (e.g., Airplane 100) flies along the flight plan and captures oblique imagery (e.g., Oblique Imagery 301) and captures or generates camera distance and orientation information (e.g., Camera Distance and Orientation 305). In some embodiments, the camera capturing aerial imagery (e.g., Camera 102) dynamically maintains focus relative to either the ground or the canopy (e.g., 25 meters above the ground), to improve the likelihood that pitch tubes are captured in focus. In various embodiments, multiple exposures are combined to improve the SNR and enable classifiers (e.g., Pitch Tube Detector 302) to distinguish pitch tubes from the surrounding tree trunk.

In action 404, the captured oblique imagery data is optionally filtered to reduce the size of the captured data. In some embodiments, captured oblique images that are fully occluded by foliage is discarded or compressed. In various embodiments, portions of captured oblique images that are occluded by foliage are compressed or sampled at a lower resolution (e.g., 12 millimeter GSD), so that only the portions of captured oblique images that potentially contain visible tree trunks and/or pitch tubes are sampled at full resolution (e.g., 4 millimeter GSD).

In action 405, the optionally filtered captured oblique imagery data and any camera orientation and distance information is written to permanent storage and transferred to a data center. In some embodiments, the aerial platform (e.g., Airplane 100) comprises permanent storage (e.g., one or more hard disks and/or solid-state drives). In some embodiments, the permanent storage is located outside the aerial platform and the optionally filtered captured oblique imagery data is transferred (e.g., via a wireless communication link through a satellite to a ground station). The optionally filtered captured oblique imagery data is otherwise transferred to a data center, e.g., by physically transporting the permanent storage from the aerial platform to the data center. In some embodiments, actions 403, 404, and 405 are performed simultaneously or partially overlapped in time. For example, as the aerial platform is flying the flight plan, many oblique images are captured, optionally filtered, and stored to a disk. In various embodiments, the captured oblique imagery data is transferred to the data center before Action 406 starts.

In action 406, the optionally filtered captured oblique imagery data is analyzed in the data center to detect bark beetles. In some embodiments, the analyzing comprises details conceptually illustrated in FIG. 3A and/or FIG. 3B. In various embodiments, the analysis is partially performed on the aerial platform itself, and the (partial) results are transferred (e.g., by wireless communication link or physical transport) to the data center.

In action 407, all or any portions of the analysis results are selectively acted upon. Exemplary actions include triggering of one or more economic management agents to perform one or more tasks (such as investigating, reporting, database updating, predicting, and/or trading). Further exemplary actions include triggering of one or more “crop management” agents (such as human agents, agents of varying degrees of autonomy, and/or other agents) to perform one or more tasks (such as inspection, harvesting, and/or pesticide deployment). As a specific example, in response to detection of bark beetle infestation in a particular tree, a forest management agency dispatches a ground crew to the particular tree. The ground crew inspects the particular tree to determine a level of infestation, and optionally inspects trees physically near the particular tree, such as by moving outward from the particular tree in a spiral pattern until a threshold distance has been traveled with no further infested trees detected. In some scenarios, the ground crew chops down and optionally burns the infested trees.

In various embodiments, action 402 and/or action 404 include internal decisions, and are therefore illustrated by diamond-style decision elements.

Elsewhere herein, various embodiments relating to bark beetle infestations are described with a time context of one year (e.g. as described in FIG. 3B Year 1 Capture Oblique Imagery 351, Year 2 Capture Oblique Imagery 352, and Year 2 Capture Other Info 353). Various other embodiments have a time context of an integer number of years, a fraction of a year, and one or more seasons of a year. Various further embodiments have a time context sufficiently long to enable at least some green attack trees to become red attack trees.

FIG. 5 illustrates selected details of embodiments of techniques for remote detection of insect infestation. Note that in the figure, for simplicity of representation, the various arrows are unidirectional, indicating direction of data flows in some embodiments. In various embodiments, any portions or all of the indicated data flows are bidirectional and/or one or more control information flows are bidirectional. GIS system 521 is a Geospatial Information System. An example of a GIS system is a computer running GIS software (e.g., ArcGIS or Google Earth). In some embodiments, the GIS System plans the image collection process (e.g., selecting the flight path based on various conditions and inputs). The GIS system is coupled to Computer 522 wirelessly, e.g., via a cellular or WiFi network.

Vehicle 520 includes an image collection platform, including one or more Cameras 501 . . . 511, Computer 522, one or more Orientation Sensors 523, one or more Position Sensor 524 elements, Storage 525, and Autopilot 528. Examples of a vehicle are a plane, e.g., a Cessna 206H, a Beechcraft B200 King Air, and a Cessna Citation CJ2. In some embodiments, vehicles other than a plane (e.g., a boat, a car, an unmanned aerial vehicle) include the image collection platform.

Cameras 501 . . . 511 include one or more image sensors and one or more controllers, e.g., Camera 501 includes Image Sensors 502.1 . . . 502.N and controllers 503.1 . . . 503.N. In various embodiments, the controllers are implemented as any combination of any one or more Field-Programmable Gate Arrays (FPGAs), Application Specific Integrated Circuits (ASICs), and software elements executing on one or more general and/or special purpose processors. In some embodiments, each image sensor is coupled to a controller, e.g., Image Sensor 502.1 is coupled to Controller 503.1. In other embodiments, multiple image sensors are coupled to a single controller. Controllers 503.1 . . . 503.N . . . 513.1 . . . 513.K are coupled to the Computer, e.g., via CameraLink, Ethernet, or PCI-Express and transmit image data to the Computer. In various embodiments, one or more of the Cameras are enabled to capture oblique imagery. In some embodiments, one or more of the Cameras are enabled to capture nadir imagery.

The Orientation Sensors measure, record, and timestamp orientation data, e.g., the orientation of cameras. In various embodiments, the Orientation Sensors include one or more Inertial Measurement Units (IMUs), and/or one or more magnetic compasses. The Position Sensor measures, records, and timestamps position data, e.g., the GPS co-ordinates of the Cameras. In various embodiments, the Position Sensor includes one or more of a GPS sensor and/or linear accelerometers. The Orientation Sensors and the Position Sensor are coupled to the Computer, e.g., via Ethernet cable and/or serial cable and respectively transmit timestamped orientation and position data to the Computer.

The Computer is coupled to the Storage e.g., via PCI-Express and/or Serial ATA, and is enabled to copy and/or move received data (e.g., from the Orientation Sensors, the Position Sensor, and/or the Controllers) to the Storage. In various embodiments, the Computer is a server and/or a PC enabled to execute logging software. The Storage includes one or more forms of non-volatile storage, e.g., solid-state disks and/or hard disks. In some embodiments, the Storage includes one or more arrays, each array include 24 hard disks. In some embodiments, the Storage stores orientation, position, and image data.

The Autopilot is enabled to autonomously steer the Vehicle. In some scenarios, the Autopilot receives information that is manually entered from the Computer (e.g., read by the pilot via a display and typed into the Autopilot).

Data Center 526 includes one or more computers and further processes and analyzes image, position, and orientation data. In various embodiments, the Data Center is coupled to the Storage via one or more of wireless networking, PCI-Express, wired Ethernet, or other communications link, and the Storage further includes one or more corresponding communications interfaces. In some embodiments, the Storage is enabled to at least at times communicate with the Data Center over extended periods. In some embodiments, at least parts of the Storage at least at times perform short term communications buffering. In some embodiments, the Storage is enabled to at least at times communicate with the Data Center when the Vehicle is on the ground. In some embodiments, one or more of the disks included in the Storage are removable, and the disk contents are communicated to the Data Center via physical relocation of the one or more removable disks. The Data Center is coupled to Customers 527 via networking (e.g., the Internet) or by physical transportation (e.g., of computer readable media). In various embodiments, Data Center 526 is entirely implemented by a personal computer (e.g. a laptop computer or a desktop computer), a general-purpose computer (e.g. including a CPU, main memory, mass storage, and computer readable media), a collection of computer systems, or any combinations thereof.

In various embodiments, Computer 522 includes CRM 529 and/or Data Center 526 includes CRM 530. Examples of CRM 529 and CRM 530 include any computer readable storage medium (e.g. media in an optical and/or magnetic mass storage device such as a disk, or an integrated circuit having non-volatile storage such as flash storage) that at least in part provides for storage of instructions for carrying out one or more functions performed by Computer 522 and Data Center 526, respectively. In various embodiments, Data Center 526 includes Modules 531, variously implemented via one or more software and/or hardware elements, operable in accordance with machine-learning techniques (e.g. as used by any combination of Pitch Tube Detector 302, Tree Trunk Detector 303, and/or Bark Beetle Detector 310 of FIG. 3A). Example software elements include operations, functions, routines, sub-routines, in-line routines, and procedures. Example hardware elements include general-purpose processors, special purpose processors, CPUs, FPGAs, and ASICs. As a specific example, Modules 531 includes one or more accelerator cards, CPUs, FPGAs, and/or ASICs implementing one or more convolved neural nets implementing all or any portions of Bark Beetle Detector 310. Further in the specific example, one or more of the accelerator cards, CPUs, FPGAs, and/or ASICs are configured to implement the convolved neural nets via one or more collections or processing elements, each collection or processing element including routing circuitry, convolution engine circuitry, pooler circuitry, and/or programmable (e.g. non-linear) function circuitry. Further in the specific example, one or more of the collections or processing elements are enabled to communicate via a memory router. In various embodiments, Vehicle 520 includes elements similar in capabilities to some implementations of Data Center 526, enabling the Vehicle to perform, e.g., all or any portions of Detect Bark Beetles 358 of FIG. 3B in near real time as oblique aerial imagery is obtained by the Vehicle.

In various embodiments, all or any portions of elements illustrated in FIG. 5 correspond to and/or are related to all or any portions of elements of FIG. 1 and FIG. 3A. For example, Vehicle 520 corresponds to Airplane 100; Cameras 501 . . . 511 correspond to Cameras 102 and 103. For another example, Cameras 501 . . . 511 are enabled to capture Oblique Imagery 301 and/or Storage 525 is enabled to store all or any portions of Oblique Imagery 301. For another example, Cameras 501 . . . 511 and/or Orientation Sensors 523 are enabled to collect all or any portions of Camera Distance and Orientation 305.

In various embodiments, all or any portions of elements illustrated in FIG. 5 are enabled to perform all or any potions of elements of FIG. 3B and FIG. 4. For example, Cameras 501 . . . 511, Computer 522, and/or Storage 525 are enabled to perform all or any portions of Year 1 Capture Oblique Imagery 351 and/or Year 2 Capture Oblique Imagery 352. For another example, Data Center 526 is enabled to perform all or any portions of Train Bark Beetle Detector 357, Detect Bark Beetles 358, and/or Analyze Filtered Imagery 406.

### CONCLUSION

Certain choices have been made in the description merely for convenience in preparing the text and drawings and unless there is an indication to the contrary the choices should not be construed per se as conveying additional information regarding structure or operation of the embodiments described. Examples of the choices include: the particular organization or assignment of the designations used for the figure numbering and the particular organization or assignment of the element identifiers (the callouts or numerical designators, e.g.) used to identify and reference the features and elements of the embodiments.

The words “includes” or “including” are specifically intended to be construed as abstractions describing logical sets of open-ended scope and are not meant to convey physical containment unless explicitly followed by the word “within.”

Although the foregoing embodiments have been described in some detail for purposes of clarity of description and understanding, the invention is not limited to the details provided. There are many embodiments of the invention. The disclosed embodiments are exemplary and not restrictive.

It will be understood that many variations in construction, arrangement, and use are possible consistent with the description, and are within the scope of the claims of the issued patent. The order and arrangement of flowchart and flow diagram process, action, and function elements are variable according to various embodiments. Also, unless specifically stated to the contrary, value ranges specified, maximum and minimum values used, or other particular specifications (such as number and configuration of cameras or camera-groups, number and configuration of electronic image sensors, nominal heading, down angle, twist angles, and/or plan angles), are merely those of the described embodiments, are expected to track improvements and changes in implementation technology, and should not be construed as limitations.

Functionally equivalent techniques known in the art are employable instead of those described to implement various components, sub-systems, operations, functions, routines, sub-routines, in-line routines, procedures, macros, or portions thereof.

The embodiments have been described with detail and environmental context well beyond that required for a minimal implementation of many aspects of the embodiments described. Those of ordinary skill in the art will recognize that some embodiments omit disclosed components or features without altering the basic cooperation among the remaining elements. It is thus understood that much of the details disclosed are not required to implement various aspects of the embodiments described. To the extent that the remaining elements are distinguishable from the prior art, components and features that are omitted are not limiting on the concepts described herein.

All such variations in design are insubstantial changes over the teachings conveyed by the described embodiments. It is also understood that the embodiments described herein have broad applicability to other imaging, survey, surveillance, and photogrammetry applications, and are not limited to the particular application or industry of the described embodiments. The invention is thus to be construed as including all possible modifications and variations encompassed within the scope of the claims of the issued patent.

1. A system comprising:
means for, in a first time epoch, capturing first oblique aerial imagery of a plurality of trees;
means for, in a second time epoch, capturing second oblique aerial imagery of the plurality of trees;
means for identifying a subset of the plurality of trees that are in a second state of bark beetle attack, based on tree health data obtained in the second time epoch;
means for updating a bark beetle detector based on at least some results of the identifying and at least tree trunk information from the first oblique aerial imagery;
means for detecting which of the plurality of trees are in a first state of bark beetle attack, based at least in part on information from the second oblique aerial imagery and using the updated bark beetle detector; and
wherein the second time epoch occurs a time delay after the first time epoch, and the time delay is sufficient for at least some of the plurality of trees of the first state to transition to trees of the second state.

2. The system of claim 1, wherein trees in the first state are more economically valuable than trees in the second state.

3. The system of claim 1, wherein the time delay is approximately one year.

4. The system of claim 1, wherein the tree health data is derived at least in part from infrared aerial imagery.

5. The system of claim 1, wherein the tree health data is derived at least in part from nadir aerial imagery.

6. The system of claim 5, wherein the nadir aerial imagery is obtained at least in part via satellite.

7. The system of claim 1, wherein the tree health data is derived at least in part from the second oblique aerial imagery.

8. The system of claim 1, wherein the bark beetle detector comprises one or more convolved neural nets, and the means for updating comprises means for updating one or more weights of the convolved neural nets.

9. The system of claim 1, wherein the tree trunk information comprises visibility of bark beetle pitch tubes.

10. The system of claim 9, wherein the pitch tubes comprise frass mixed with exuded pitch.

11. The system of claim 1, wherein the trees of the first state are harvestable and the trees of the second state are not harvestable.

12. The system of claim 1, wherein the trees of the first state are green attack trees and the trees of the second state are red attack trees.

13. A method comprising:
in a first time epoch, capturing first oblique aerial imagery of a plurality of trees;
in a second time epoch, capturing second oblique aerial imagery of the plurality of trees;
identifying a subset of the plurality of trees that are in a second state of bark beetle attack, based on tree health data obtained in the second time epoch;
updating a bark beetle detector based on at least some results of the identifying and at least tree trunk information from the first oblique aerial imagery;
detecting which of the plurality of trees are in a first state of bark beetle attack, based at least in part on information from the second oblique aerial imagery and using the updated bark beetle detector; and
wherein the second time epoch occurs a time delay after the first time epoch, and the time delay is sufficient for at least some of the plurality of trees of the first state to transition to trees of the second state.

14. The method of claim 13, wherein trees in the first state are more economically valuable than trees in the second state.

15. The method of claim 13, wherein the time delay is approximately one year.

16. The method of claim 13, wherein the tree health data is derived at least in part from infrared aerial imagery.

17. The method of claim 13, wherein the tree health data is derived at least in part from nadir aerial imagery.

18. The method of claim 17, wherein the nadir aerial imagery is obtained at least in part via satellite.

19. The method of claim 13, wherein the tree health data is derived at least in part from the second oblique aerial imagery.

20. The method of claim 13, wherein the bark beetle detector comprises one or more convolved neural nets, and the updating comprises updating one or more weights of the convolved neural nets.

21. The method of claim 13, wherein the tree trunk information comprises visibility of bark beetle pitch tubes.

22. The method of claim 21, wherein the pitch tubes comprise frass mixed with exuded pitch.

23. The method of claim 13, wherein the trees of the first state are harvestable and the trees of the second state are not harvestable.

24. The method of claim 13, wherein the trees of the first state are green attack trees and the trees of the second state are red attack trees.

25. A tangible computer readable medium having a set of instructions stored therein that when executed by a processing element cause the processing element to perform and/or control operations comprising:
in a first time epoch, capturing first oblique aerial imagery of a plurality of trees;
in a second time epoch, capturing second oblique aerial imagery of the plurality of trees;
identifying a subset of the plurality of trees that are in a second state of bark beetle attack, based on tree health data obtained in the second time epoch;
updating a bark beetle detector based on at least some results of the identifying and at least tree trunk information from the first oblique aerial imagery;
detecting which of the plurality of trees are in a first state of bark beetle attack, based at least in part on information from the second oblique aerial imagery and using the updated bark beetle detector; and
wherein the second time epoch occurs a time delay after the first time epoch, and the time delay is sufficient for at least some of the plurality of trees of the first state to transition to trees of the second state.

26. The tangible computer readable medium of claim 25, wherein trees in the first state are more economically valuable than trees in the second state.

27. The tangible computer readable medium of claim 25, wherein the time delay is approximately one year.

28. The tangible computer readable medium of claim 25, wherein the tree health data is derived at least in part from infrared aerial imagery.

29. The tangible computer readable medium of claim 25, wherein the tree health data is derived at least in part from nadir aerial imagery.

30. The tangible computer readable medium of claim 29, wherein the nadir aerial imagery is obtained at least in part via satellite.

31. The tangible computer readable medium of claim 25, wherein the tree health data is derived at least in part from the second oblique aerial imagery.

32. The tangible computer readable medium of claim 25, wherein the bark beetle detector comprises one or more convolved neural nets, and the updating comprises updating one or more weights of the convolved neural nets.

33. The tangible computer readable medium of claim 25, wherein the tree trunk information comprises visibility of bark beetle pitch tubes.

34. The tangible computer readable medium of claim 33, wherein the pitch tubes comprise frass mixed with exuded pitch.

35. The tangible computer readable medium of claim 25, wherein the trees of the first state are harvestable and the trees of the second state are not harvestable.

36. The tangible computer readable medium of claim 25, wherein the trees of the first state are green attack trees and the trees of the second state are red attack trees.

37-51. (canceled)
